(19) United States
(12) Patent Application Publication
(10) Pub. No.: US 2012/0151909 A1
(43) Pub. Date: Jun. 21, 2012

(54) LOAD SENSING HYDRAULIC SYSTEM

(75) Inventor: Richard HACKER, Quebec (CA)

(73) Assignee: ACE, Accent Controles Electroniques Inc.

(21) Appl. No.: 13/035,825

(22) Filed: Feb. 25, 2011

(30) Foreign Application Priority Data
Dec. 17, 2010 (CA) 2,725,851

(51) Int. Cl. F16D 31/02

(52) U.S. Cl. 60/445

(57) ABSTRACT

A hydraulic system incorporating a modified spool controlling hydraulic fluid flow to non-load sensing functions for use with a load-sensing pump is described. The hydraulic system comprises a hydraulically piloted stroke valve for providing a load sensing signal to the load-sensing pump when the non-load sensing functions are operated.

### CROSS-REFERENCE TO RELATED PATENT APPLICATIONS

This application claims the benefit of Canada Priority Application 2,725,851, filed Dec. 17, 2010, including the specification, drawings, claims and abstract, is incorporated herein by reference in its entirety.

### FIELD OF THE INVENTION

The invention relates generally to a versatile load sensing hydraulic system and in particular to a load sensing hydraulic system that uses a hydraulically piloted stroke valve to provide a load sensing signal.

### BACKGROUND OF THE INVENTION

The operation of vehicles such as those used for ploughing or scraping snow and/or ice from roads, airport runways and similar surfaces and for spreading traction enhancing materials such as sand and/or salt requires the installation of a hydraulic system that supplies power to operate the various components of spreader and plough equipment. The usual installation includes a single gear pump that pushes hydraulic fluid through an open center valve with a power beyond connection, which is used to operate the plough functions. The power beyond is connected to the pressure of the spreader valve, from where it returns to a hydraulic fluid tank or reservoir, or is partially routed to the spreader's hydraulic motors. The principal problem of this circuit is the stoppage of the spreader when any plough function is operated. Various solutions have been used to remedy this problem.

Tandem pumps may be used in two completely separate hydraulic circuits. One pump supplies the plough hydraulic functions, the other one supplies the spreader only. Simultaneous operation is rendered possible for both the plough and the spreader, but several major inconveniences remain. In typical sander and plough truck applications the sander pump displaces around 10 GPM/1000 RPM, and the plough pump around 8 GPM/1000 RPM. These systems are more expensive, more complicated, require a larger hydraulic fluid reservoir and are highly inefficient energy wise.

An intermittent solution is the use of a priority valve. However this solution is still beset by the problems of a fixed displacement pump system. The impossibility of having very big differences in flow requirements, for example from 2 GPM to 30 GPM as commonly encountered in the field, cannot be overcome with a single fixed displacement pump.

All the above systems see their problems compounded by the use of four season bodies that incorporate the sander into a dump box. Dumping the dump box fast is a requirement for efficient operation of these units, but it increases the maximum flow requirements on the hydraulic system.

Another solution is the use of a variable displacement piston pump that is usually controlled by sensing the load. The load sensing pump works in conjunction with closed center valves that share a common pressure supply, which is the pump. This constitutes a normal load sensing circuit, with all its usual benefits. A problem associated with this solution is the very high cost of load sensing valves and pumps.

Other inconveniences associated with the use of typical load sensing valves include complexity that goes way beyond the level of knowledge of the average user or mechanic. At the same time this complexity renders these systems very fragile to any contamination such as dirt or water, requiring expensive filtration systems. All this reduces reliability while driving up the purchase and maintenance costs.

Another solution is the use of a stroke valve that is actuated by an external signal when the hydraulic functions are operated. The stroke valve, when actuated by the external signal in conjunction with the operation of a function valve controlling the hydraulic function, provides a load sensing signal to the pump. Although this solution works, it requires an external signal be generated to operate the stroke valve appropriately when one of a hydraulic function is operated.

Therefore, there is a need for a load sensing hydraulic system capable of providing hydraulic fluid to operate various components of equipment combining continuous and intermittent uses such as plough/spreader type installations without requiring a separate signal for control.

### SUMMARY OF INVENTION

In accordance with the present disclosure there is provided a hydraulic system for operating hydraulic functions comprising a reservoir for hydraulic fluid; a load sensitive variable displacement pump, controllable by a load sensing signal, for pumping hydraulic fluid from the reservoir; a valve block comprising a function valve controlling flow of the hydraulic fluid from the pump to a hydraulic function through movement of a spool between a plurality of positions comprising a first position allowing the hydraulic fluid to flow through a neutral passage of the valve block and stopping the flow of the hydraulic fluid to the hydraulic function; and a second position stopping the flow of the hydraulic fluid through the neutral passage and allowing the hydraulic fluid to flow to the hydraulic function, wherein the spool stops the flow of the hydraulic fluid through the neutral passage before allowing the hydraulic fluid to flow to the hydraulic function when the spool is moved from the first position to the second position; and a hydraulically piloted stroke valve, for providing the load sensing signal to the load sensing pump, the stroke valve having a spool moveable between a plurality of positions comprising a first position in which hydraulic fluid under pressure from the pump is connected to the output of the stroke valve providing the load sensing signal; and a second position in which the output of the stroke valve is connected to a hydraulic fluid return line for returning hydraulic fluid to the reservoir; and an pilot port connected to the neutral passage of the valve block for moving the spool of the stroke valve between the first and second positions.

In accordance with the present disclosure there is further provided a valve block for use with a load sensing pump, the valve block comprising a function valve for controlling flow of hydraulic fluid to a hydraulic function through movement of a spool between a plurality of positions comprising a first position allowing hydraulic fluid to flow through a neutral passage of the valve block and stopping the flow of hydraulic fluid to the hydraulic function; and a second position stopping the flow of hydraulic fluid through the neutral passage and allowing hydraulic fluid to flow to the hydraulic function, wherein the spool stops the flow of hydraulic fluid through the neutral passage before allowing hydraulic fluid to flow to the hydraulic function when the spool is moved from the first position to the second position; and a hydraulically piloted stroke valve, for providing the load sensing signal, the stroke valve having a spool moveable between a plurality of positions comprising a first position in which hydraulic fluid under pressure is connected to the output of the stroke valve providing the load sensing signal; and a second position in which the output of the stroke valve is connected to a hydraulic fluid return line; and a pilot port connected to the neutral passage of the valve block for moving the spool of the stroke valve between the first and second positions.

### BRIEF DESCRIPTION OF THE DRAWINGS

FIG. 1 depicts a block diagram of a hydraulic system that allows a proportional or on-off function valve to operate with a load sensing pump;

FIG. 2 depicts a block diagram of the hydraulic system of FIG. 1 after the spool of the function valve has been moved;

FIGS. 3a and 3b, referred to collectively as FIG. 3 herein, show a hydraulic schematic of an embodiment of the hydraulic system;

FIGS. 4a and 4b, referred to collectively as FIG. 4 herein, shows a hydraulic schematic of a further illustrative embodiment of the hydraulic system; and

FIGS. 5a and 5b, referred to collectively as FIG. 5 herein, shows a hydraulic schematic of a further illustrative embodiment of the hydraulic system.

### DETAILED DESCRIPTION

As described further herein, the hydraulic system allows combining the benefits of true load sensing with the simplicity of hydraulic pressure compensated systems. Typical applications of such a hydraulic system have some parts of the system continuously in use while others are used on an intermittent base. An example for this kind of use is the hydraulic systems used for the operation of ploughing and spreading trucks. In this application part of the system, the sander, is running for very long periods of time with rather low flow and pressure requirements, while another part of the system, the plough equipment, runs intermittently with much higher flow and pressure requirements. The variable displacement load sensing pump is capable of adapting to these changing demands. The present disclosure is aimed at rendering use of a load sensing pump affordable while simplifying the system components.

A load sensing pump can vary the output based on the requirements of the function. The use of load sensing pumps may provide a benefit in terms of efficiency; however, load sensing valves typically need to be used to control the function in order to provide a load sensing signal to the pump. Load sensing valves may be expensive and complex, and as such it is undesirable to use them for non-load sensing applications, such as proportional or on-off functions. However, it is desirable to incorporate both load sensing valves and proportional or on-off valves into a single hydraulic system that uses the efficient load sensing pump.

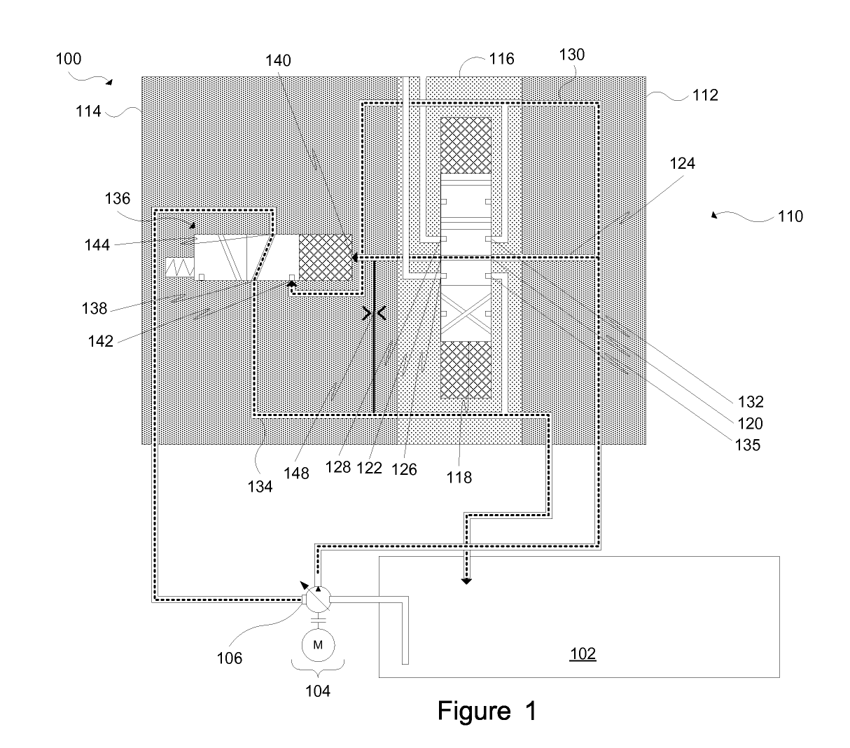

FIG. 1 depicts a block diagram of a hydraulic system that allows use of a proportional or on-off function valve with a load sensing pump. It will be appreciated that FIG. 1 is used to describe the overall functioning of the hydraulic system, and does not represent a physical cross-section of an actual hydraulic system. As such, components of the hydraulic system are not to scale and other components typically used for an actual hydraulic system, such as fasteners and seals are not depicted.

The hydraulic system 100 may be used to provide hydraulic fluid (represented by the dotted line) to one or more hydraulic functions (not shown). The hydraulic system 100 comprises a reservoir 102 for holding the hydraulic fluid. A variable displacement load sensing pump, or simply the pump, 104 pumps the hydraulic fluid from the reservoir 102 through one or more hydraulic circuits. The pump 104 comprises a load sensing signal port 106 that receives a hydraulic signal. Based on the hydraulic signal, the pump 104 controls the displacement. That is, the pump 104 controls its output based on the signal provided at the load sensing signal port 106.

The flow of the hydraulic fluid to a hydraulic function is controlled by a function valve block, or simply the valve block, 110. The valve block 110 comprises an inlet cover 112 and an outlet cover 114. The valve block 110 also includes one or more function valves located in between the inlet cover 112 and the outlet cover 114. A single function valve 116 is depicted in FIG. 1. The inlet and outlet covers 112, 114 provide the appropriate physical connections for connecting the hydraulic system. As described further below, the inlet or outlet cover may also comprise a hydraulically operated stroke valve for providing a load sensing signal to the

The function valve 116 depicted in FIG. 1 comprises a valve body and a spool 118 that can move between a plurality of positions. The spool 118 of FIG. 1 is a 3-way spool, which allows the spool 118 to be moved to one of three positions. The spool 118 is depicted in the neutral position in FIG. 1. In this position, the spool connects a neutral passage inlet port 120 to a neutral passage outlet port 122, which allows the hydraulic fluid to flow through a neutral passage 124 of the valve block 110. Also, in this position, the spool 118 stops the hydraulic fluid from flowing to the hydraulic function through either work port A 126 or work port B 128.

As depicted in FIG. 1, the valve block 110 may include a parallel passage 130 that can receive the hydraulic fluid under pressure from the pump 104. The parallel passage 130 allows the hydraulic fluid under pressure to by-pass the spool 118 of the function valve 116 and flow to another part of the hydraulic system, such as another function valve (not shown) or the outlet cover 114. A parallel passage port 132 of the function valve 116 may be connected to the parallel passage 130. The valve block 110 may also include a tank passage 134 that allows hydraulic fluid to return to the reservoir 102. A tank return port 135 of the function valve 116 may be connected to the tank passage 136.

When the spool 118 is in the neutral position depicted in FIG. 1, the spool 118 connects the neutral passage inlet port 120 to the neutral passage outlet port 122, which will allow hydraulic fluid to flow through the neutral passage 124 of the valve block 110. In the neutral position depicted in FIG. 1, all other ports of the spool 118 are dead-headed so that no hydraulic fluid flows to the hydraulic function. When moved to the ‘in’ position—a position corresponding to a downward movement of spool 118 as depicted in FIG. 1—the spool 118 closes the neutral passage 124 as described further below. Also, in this position, the spool 118 connects the work port A 126 to the parallel port 132 and the work port B 128 to the tank return port 136. In this position, hydraulic fluid under pressure is allowed to flow to the hydraulic function through the parallel passage 130 and work port A 126 and is returned to the reservoir by flowing through work port B 128 and the tank passage 134. In the ‘out’ position, the connections of the work ports 126, 128 are reversed, so that hydraulic fluid may flow through the hydraulic function in the opposite direction. The spool 118 is machined so that when it is being moved from the neutral position to either the ‘in’ or ‘out’ position the neutral passage 130 is closed before the other passages are opened. That is the spool stops hydraulic fluid flowing through the neutral passage 124 before allowing fluid to flow to the hydraulic function as the spool is move from the neutral position.

Although the spool 118 is depicted as a 6-port 3-way valve, other types of spools may be used. However, the spool must close the neutral passage 124 of the valve block before allowing the hydraulic fluid to flow to the work port of the spool.

The outlet cover 114 as depicted in FIG. 1 includes a hydraulically piloted stroke valve 136. The stroke valve 136 provides the load sensing signal to the pump 104. The stroke valve 136 is depicted as a four-port two way hydraulically piloted valve. A first port 138 of the stroke valve 136 is connected to the reservoir 102 through the tank passage 134. A second port 140 of the stroke valve 136 is connected to the neutral passage of the valve block 110. The second port 140 controls the position of the spool of the stroke valve 136, that is a high pressure at the second port will cause the spool to move from a first position to a second position. The second port may be referred to as a pilot port as the pressure at the port provides the piloting of the spool. A third port 142 of the stroke valve 136 is connected to the pump pressure supply line through the parallel passage 130 of the valve block 110. A fourth port 144 of the stroke valve 136 is connected to the load sensing input port 106 of the pump 104.

The outlet cover 114 may also provide a small orifice (OB) 148 connection between the second port connected to the neutral passage 130 of the valve block 110 and the tank return passage. This orifice allows any hydraulic fluid in the passage to drain to the reservoir when the spool of the function valve 116 is moved from the neutral position. Although an orifice 148 is describe, other means for bleeding off the pressure in the line once the neutral passage is closed may be used.

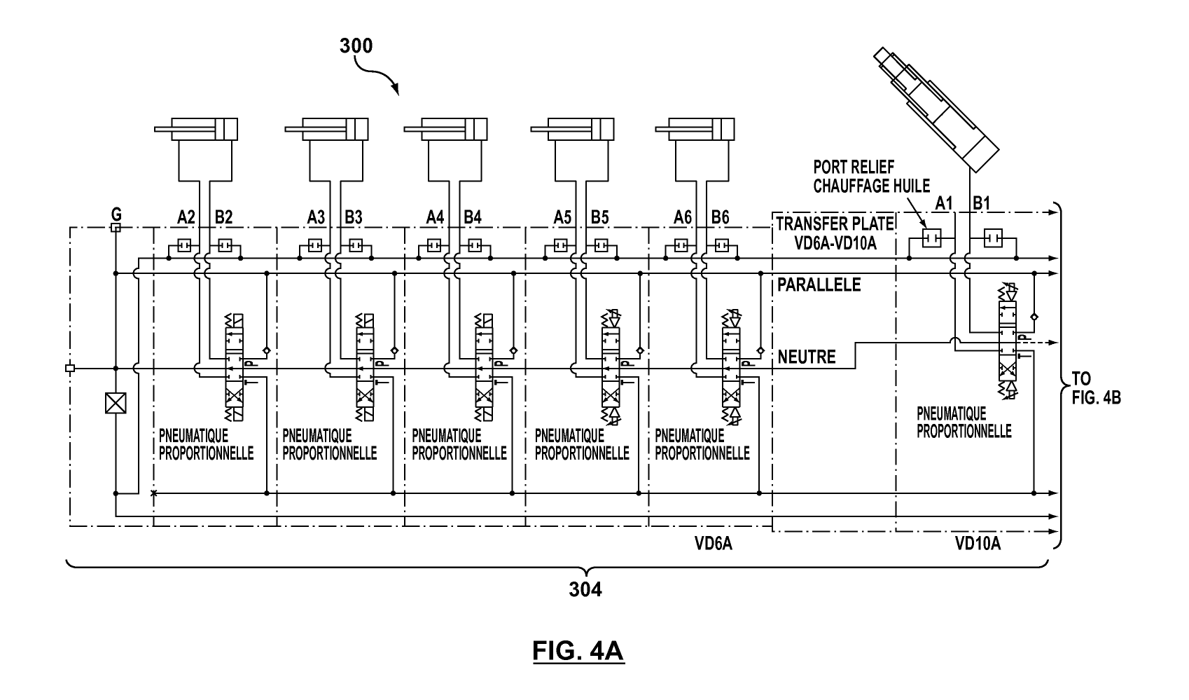

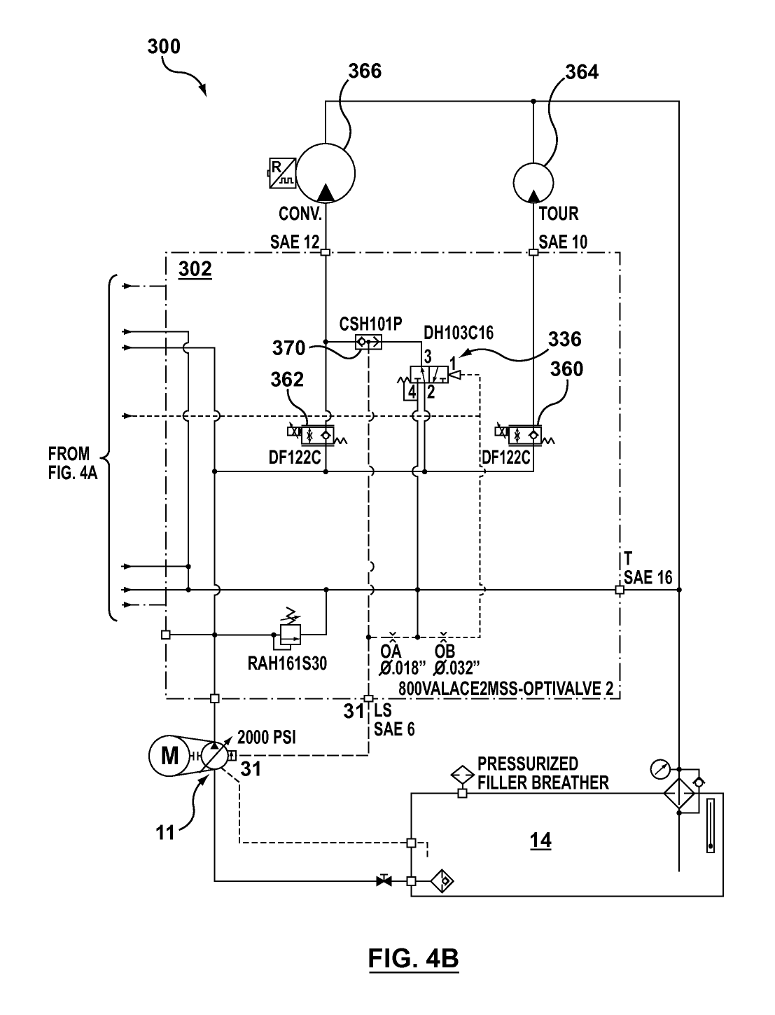

The size of this orifice, or means for bleeding off the pressure depends on several considerations. It must be big enough to let oil trapped between the spool of the single function valve 116 and the stroke valve 136 escape fast enough to allow for rapid shifting of the stroke valve 136. It must also be big enough so any leakage oil between the neutral and parallel passages of the single function valve cannot build up enough pressure to shift the stroke valve 136 when the single function valve 116 is not in the neutral position. A further consideration is its function as a warm up circuit that lets a small amount of oil circulate through the hydraulic system 100 when it is in the neutral position. This circulation is of importance when the hydraulic system has long idling periods in its intended application. Another factor that must be considered is the spring pre load of the stroke valve itself, which determines what leakage pressure is acceptable. On the other hand it must be small as possible, as it reduces the overall efficiency of the system. As there are all these factors to be considered, practical tests, which will be apparent to one of ordinary skill in the art, are the easiest way to determine its exact size. In assemblies such as illustrated in FIG. 4, orifice 148 sizes of 0.027″ to 0.034″ seem to offer an acceptable compromise between these competing requirements.

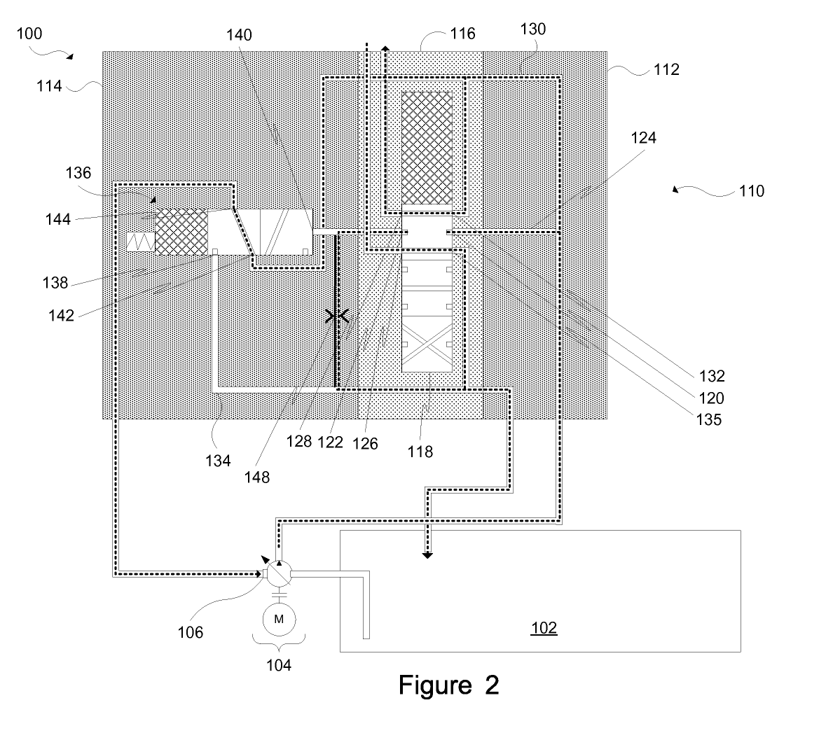

Referring to FIGS. 1 and 2, when the spool of the function valve 116 is in the neutral position (FIG. 1), the spool 116 allows the hydraulic fluid to flow through the neutral passage 124 from the pump 104 to the stroke valve 136. The pressure from the hydraulic fluid moves the spool of the stroke valve 136 so that the load sensing signal port 106 of the pump 104 is connected to the tank return passage 134, providing a low pressure signal to the pump causing the pump to enter the low pressure standby state. In this condition all pump outlet flow is blocked by either the function valve 116 or the stroke valve 136 and the pump maintains a low pressure stand-by pressure, which makes up for any internal leakages. Accordingly, when the spool of the function valve 116 is in a position such that no hydraulic fluid is flowing to the hydraulic function, the pump will be in its low-pressure stand by mode and so provide minimal pumping, and consume less energy.

FIG. 2 depicts the hydraulic system 100 when with the spool 118 of the function valve 116 moved to the ‘in’ position. When the function valve 116 is operated, the spool 118 moves from the neutral position to another position as depicted in FIG. 2. As the spool 118 moves to this position, the spool closes the neutral passage 124 so that no hydraulic fluid flows through the neutral passage 124. Hydraulic fluid trapped in the outlet cover 114 when the neutral passage 124 is closed by the spool 118 is bled off to the reservoir 102 through orifice OB 148 or other bleed off means. As such, the piloting signal of the stroke valve 136 provided at the second port 140 drops and the spool of the stroke valve 136 moves to the position depicted in FIG. 2. In this position, the stroke valve 136 connects the load sensing signal port 106 of the pump 104 to the parallel passage 130 of the valve block 110, which in turn is connected to the pump output. With the load sensing signal port 106 connected to the pump output, the pump will go to its high pressure stand-by pressure. Further movement of the spool 118 of the function valve 116 connects the parallel passage port 132 of the function valve 116 that is now at pump high pressure stand-by pressure to the work ports A or B of the function valve. As the spool of the function valve continues to move to the position shown in FIG. 2, hydraulic fluid is provided to the hydraulic function through one of the work ports 126, 128. The hydraulic fluid may return to the tank 102 through the spool 118 and the tank passage 134 of the valve block 110, or through another connection not depicted.

As described above, when the spool 118 of the function valve 116 moves from the neutral position, it first closes the neutral passage 124 before opening another passage. As a result the spool of the stroke valve 136, which is piloted by the pressure of the neutral passage 124, moves and connects the pump output to the load sensing signal port of the pump, causing the pump to go into its high pressure stand-by mode.

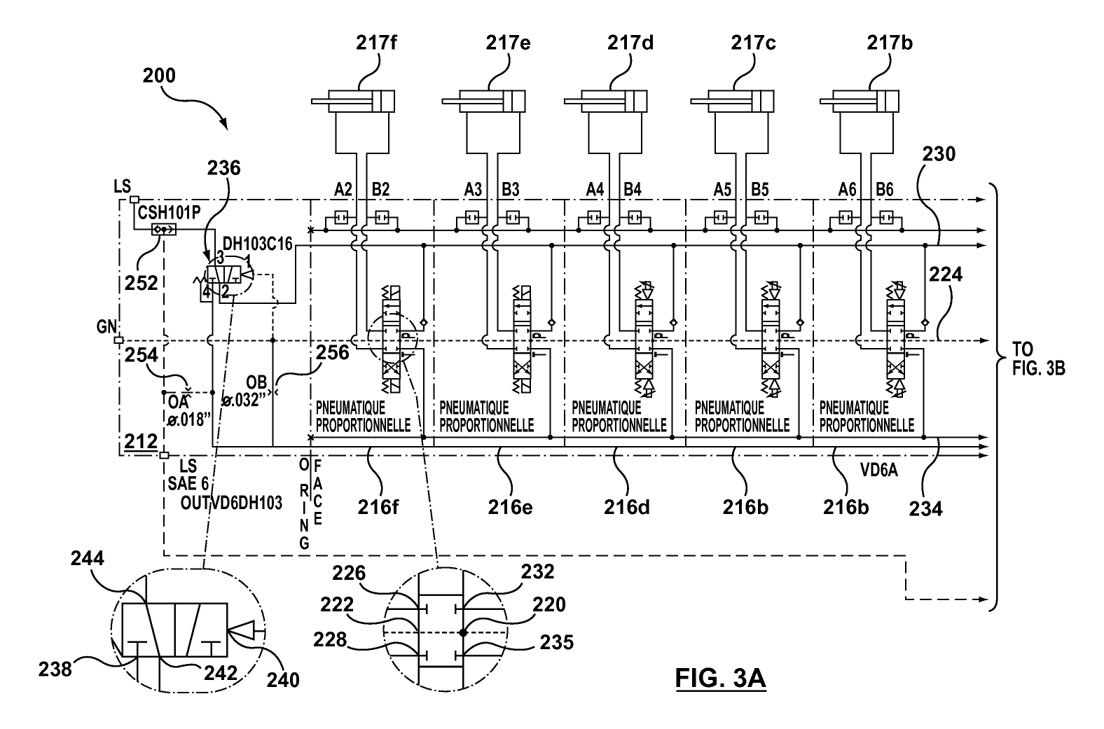

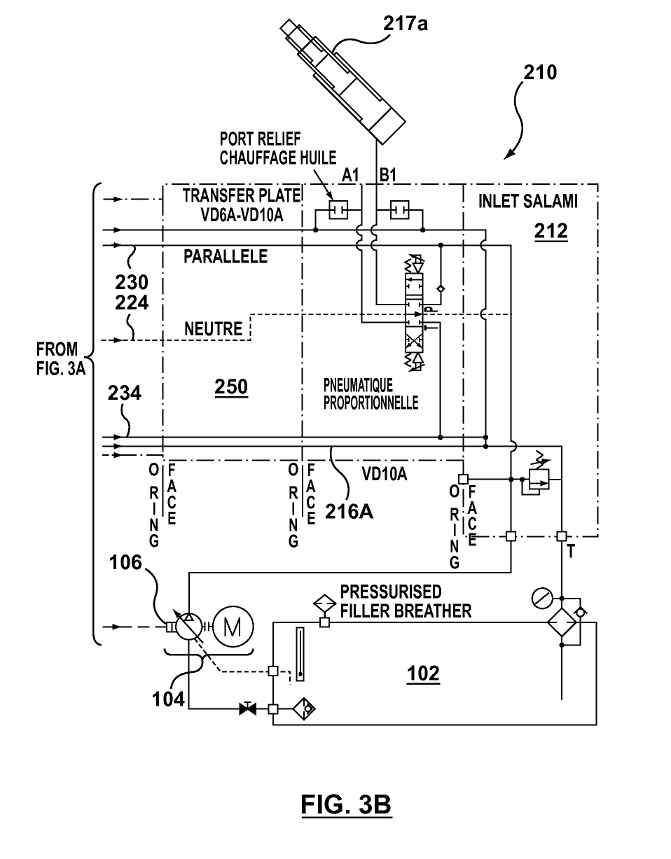

FIG. 3 shows a hydraulic schematic of a further embodiment of the hydraulic system 200. A load sensing variable displacement pump 104 pumps hydraulic fluid from a reservoir 102 through a hydraulic function valve block 210 and to a stroke valve 236. The stroke valve 236 is depicted as a three way, hydraulic piloted two position valve, such as for example a Parker DH103C16. The valve block 210 may comprise an inlet cover 212, an outlet cover 214 and one or more function valves 216a-216f (referred to generally as 216) positioned between the two covers 212, 214. The schematic of FIG. 3 depicts six function valves. As depicted, different valve sizes (216a compared to 216b-216f) may be combined together through a transfer plate 250.

The hydraulic function valves 216 may be a standard commercially available valve. For example it may be a six way valve having six ports. The ports include:

Port 1—a neutral passage inlet 220

Port 2 is a neutral passage outlet 222

Port 3 is a parallel passage inlet 232

Port 4 is a tank passage port 234

Port 5 is work port B 226

Port 6 is work port A 228

Oil from the pump 102 enters the valve block 210 through the inlet cover 212, then goes through a number of function valves 216 (six depicted in FIG. 3), and then enters the outlet cover 214. Replacing a normal outlet cover of the valve block 210 is an outlet cover 214 incorporating the stroke valve 236.

The stroke valve 236 is a hydraulically piloted four port two position valve. Port 1 (238) of the stroke valve 236 is connected to the reservoir 102 through a tank return passage 235 of valve block 210. Port 2 (240) of the stroke valve 236 is connected to a neutral passage 224 of the valve block 210. Port 3 (242) of the stroke valve 236 is connected to the pump pressure supply line through the parallel passage 230 of the valve block 210. Port 4 (244) of the stroke valve 236 is connected to the load sensing input port 106 of the pump 104.

Each of the function valves 216 controls the flow of hydraulic fluid to and from a respective hydraulic function 217a-217f (referred to generally as hydraulic function 217). The hydraulic function 217 may be any suitable function controlled or operated by the flow of hydraulic fluid such as a hydraulic cylinder, a hydraulic motor, a hydraulic driven compressor, etc.

FIG. 3 depicts two different sized valves, namely 216a and 216b-216f, connected together through a transfer plate 250. The fact that there are two valve sizes illustrated in FIG. 3 is irrelevant to the operation of the valve assembly as long as the spool of each of the function valves 216 are machined to close the passage of the spool separating Port 1 (220) and Port 2 (222) of the function valve 216, before the spool connects the work ports, Port 5 (226) and Port 6 (228) to either of Port 3 (232) i.e. the parallel passage inlet port or Port 4 (234) i.e. the tank return port, of the same function valve 216.

FIG. 3 depicts a shuttle valve 252 in the outlet cover 214. The shuttle valve 252 is not required but may be included to make adding other load sensing valves easier. The shuttle valve 252 provides the highest signal to the load sensing input of the pump.

The spools of the function valves 216 are machined to close the passage of the respective function valve separating Port 1 (220) and Port 2 (222), before this same valve connects Port 5 (226) or Port 6 (228) to either Port 3 (232) or Port 4 (234). This spool modification allows for the use of standard valve bodies incorporating these spools in conjunction with load sensing pumps, when a stroke valve as described herein is used.

The operation of the hydraulic system 200 of FIG. 3 will now be described. For the sake of clarity, the operation of a valve block incorporating a single function valve 216a is first described, followed by the operation of a function valve block incorporating a plurality of function valves.

Upon start-up of the load sensing pump, the pump is in its maximum displacement position. With the spool of the function valve 216a in the neutral position and the load sensing pump running, oil enters the neutral passage 224 and the parallel passage 230 of the valve block 210. The pump 104 strives to maintain its low pressure stand-by pressure. The oil entering the neutral passage 224 of the valve block 210 goes to Port 2 (240) of the stroke valve 236. The oil going through the parallel passage 230 of the function valve block 236 is dead headed by the spool of the function valve 216a and reaches Port 3 (242) of the stroke valve 236. Some oil may pass through Port 3 (242) of the stroke valve 236 and come out Port 4 (244)of the stroke valve 236, leading to the load sensing signal port 106 of the pump, but also to a bleed-off orifice OA 254 having a size of for example 0.018″. As the low pressure stand-by pressure of the pump is reached upon start-up of the pump, the pressure applied to Port 2 (240) of the stroke valve 236 will shift the spool of the stroke valve thereby dead heading Port 3 (242) of the stroke valve 236 connected to the parallel passage 230 while draining the load sensing signal to the reservoir 102 through Port 1 (238) of the stroke valve 236. In this condition all pump outlet flow is blocked by either the function valve 216a or the stroke valve 236 and the pump maintains its low pressure stand-by pressure by making up for internal leakages only. An Orifice OB 256 allows for oil reaching Port 2 (240) of the stroke valve to escape back to the reservoir 102, but is small enough to keep the stroke valve 236 in the shifted position as the pump maintains its stand-by pressure. For example, the size of orifice OB 256 may be 0.032″. At the same time this orifice OB 256 provides a warm-up circuit for extreme cold weather operation of the hydraulic system 200 when all spools are in the neutral position.

This warm-up function is useful for applications such as on snow clearing trucks. It prevents thermal shock conditions as observed in circuits that combine intermittent functions with continuous ones. These very different uses may lead to differences in temperature between the intermittent functions, which may become cold when not being used, and continuous functions, which may have a higher temperature. This temperature difference may be eliminated, or reduced, by this warm-up function.

When the spool of the function valve 216a starts moving from the neutral position Port 2 (240) of the stroke valve 236, which is the pilot port, receives no more oil. Any oil in the neutral passage between the neutral passage outlet Port 2 (222) of the spool of the function valve 216a and the pilot Port 2 (240) of the spool of the stroke valve 236 will be bled off to reservoir through orifice OB 256, although other bleed off mechanisms may be used to allow the hydraulic fluid to return to the reservoir 102. This will cause the spool of the stroke valve 236 to shift connecting Port 3 (242) to Port 4 (244). In this stroke valve position, the pump pressure line, that is the parallel passage 230, is connected to the pump load sensing signal line connected to the load sensing signal port 106 of the pump 104, causing the pump to go to its high pressure stand-by pressure. Further movement of the spool of the function valve 216a allows the hydraulic fluid in the parallel passage 230, which is at high pressure stand-by pressure, to flow to the hydraulic function 217a through work port A (228) or work port B (226) and return to the reservoir 102.

Although described as controlling only a single hydraulic function 217a, the function valve block 210 may comprise multiple function valves controlling different hydraulic functions as depicted in FIG. 3. The operation of a valve block having a plurality of function valves is set out below.

When more than one function valve 216a-216f is present between the inlet cover 212 and the outlet cover 214 of the valve block 210 the oil flow of the neutral passage 224 goes through all of the spools of the function valves 216 before reaching the stroke valve at Port 2 (240). Thus any one spool moved out of its neutral position will generate the load sensing signal to pressurize the hydraulic system 200 as described above with the functioning of the system with respect to a single function valve 216a.

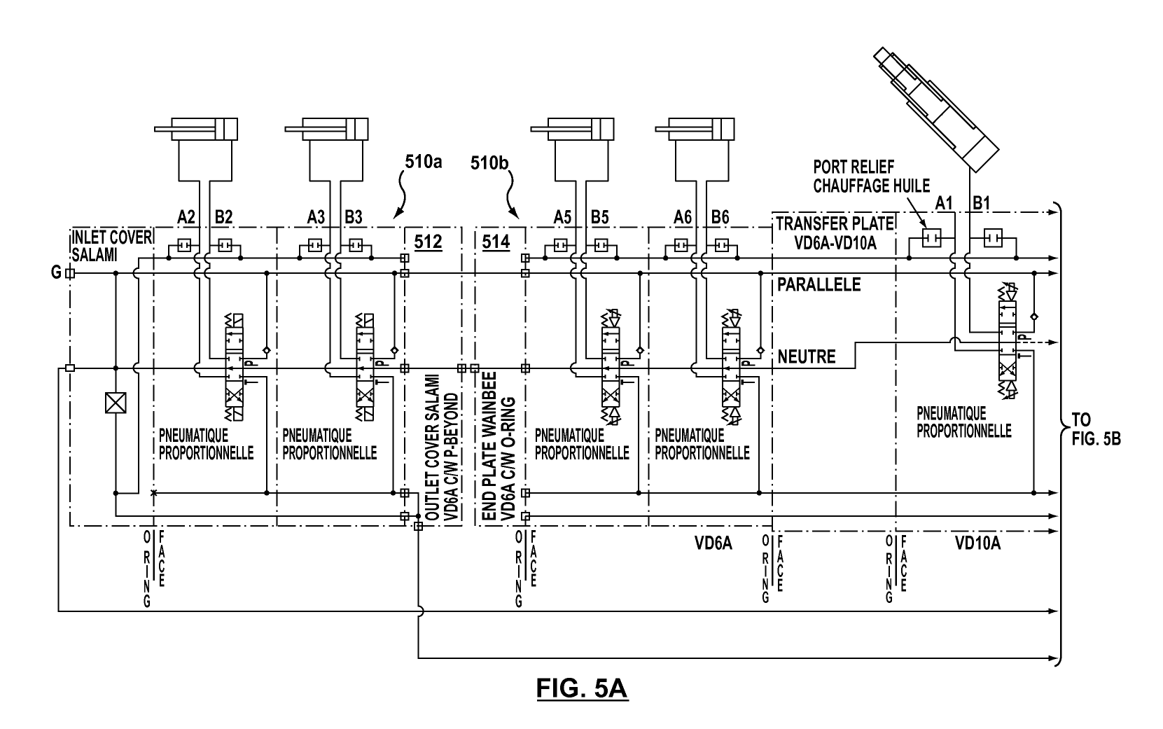

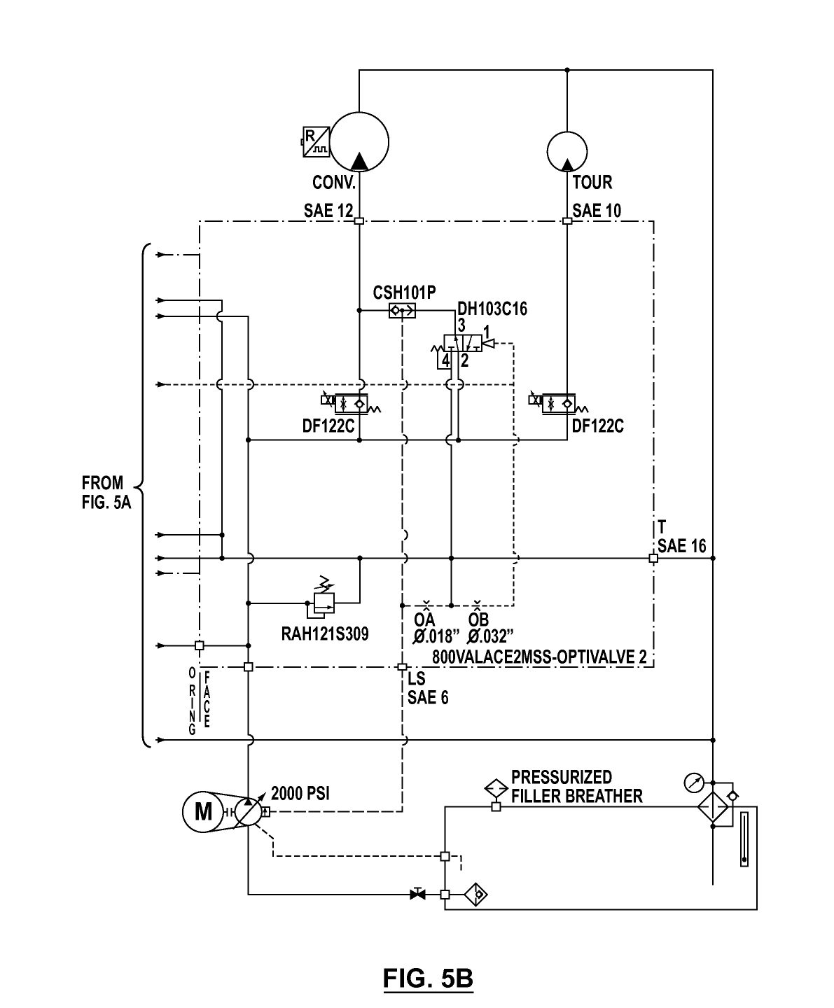

FIG. 4 shows a hydraulic schematic of a further illustrative embodiment of a hydraulic system 300. The embodiment is directed to a hydraulic system for operating plough/hoist/spreader type equipment. The plough/hoist/spreader embodiment has a load sensing valve block section 302 for controlling the spreader equipment as well as a proportional valve block section 304 for controlling the plough and hoist equipment. The cartridges used for operating the sander functions in this embodiment are normally closed, pressure compensated flow control valves. In a sander truck type application the conveyor pressure is always higher than the spinner pressure, and as such only the conveyor valve is used to create a load sensing signal. The plough/hoist valve block section 304 is a combination sandwich valve block consisting of physically small function valves 216b-216f for the plough (low flow) functions and one or more bigger valves 216a for the hoist (high flow) function. The high and low flow sections are connected together by a transfer plate 250. All respective neutral, parallel and tank passages are connected together. All spools have the same functions as described above. The above has described the stroke valve as being incorporated into the outlet cover; however, in the embodiment of FIG. 4, the stroke valve 336 is incorporated into the inlet side. In particular, the stroke valve 336 is incorporated into a valve block section 302 incorporating load sensing function valves 360, 362 for the continuous spreader equipment 364, 366. As depicted in FIG. 5, it is also possible to divide the valve block 210 into two separate blocks 510a and 510b. Parallel passages of both blocks are connected to the pump pressure. A first block 510a provides the piloting signal for the stroke valve through a standard outlet cover 512 with a power beyond feature that is routed into an outlet cover 514 of block 510b that has a separate port for the neutral passage connected to the stroke valve and the function valves. The outlet covers of both blocks have the parallel passages blocked. The stroke valve may be incorporated into the valve block 510b.

A shuttle valve 370 arrangement is connected to the load sensing pressure signals of the load sensing valve block 302 and the proportional valve block section 304 provided by the stroke valve 336, providing the highest pressure signal to the load sensing pressure port 106 of the load sensing pump 104 to control the fluid flow of the pump. As the signal coming from the plough valve is equal to the pressure of the pump pressure outlet when the neutral passage of the proportional valve block is closed i.e. when a function valve 216a-216f is moved, the pump will go to high pressure stand-by when the signal from the plough valve block is received. The sander valve spools are of the pressure compensated type, which means that any change in inlet pressure does not influence their outlet flow.

An additional refinement of this system is the installation of an orifice in the load sensing line before it enters the pumps load sensing signal port 106. Although not necessary, the goal of this refinement is the suppression of pressure spikes in the system that may occur when the pump strokes: Depending on the pumps design various size orifices will reduce the pressure spiking while maintaining rapid system response.

The benefits of using a load sensitive variable displacement pump are well known in the art. By using the stroke valve 136, 236 or 336 as described herein, non-load sensing function valves may be used in place of more expensive load sensing valves, while maintaining the benefits of the load sensitive variable displacement pump. Furthermore, by using spools in the function valves that close the neutral passage before connecting the parallel port to a work port, it is possible to use a hydraulically actuated stroke valve that is controlled by the hydraulic fluid passing through the neutral passage, simplifying the hydraulic system.

Through the use of the stroke valve as described above, non-load sensing valves may be used in conjunction with a load sensing pump, by simply modifying the valve spool. This eliminates the need for an externally generated signal that will pressurize (stroke) the pump, making the system simpler, less expensive, easier to install and more reliable.

Any function controlled by a spool valve may require proportional control such as for example a wing front post lift, a side wing lift, the truck box hoist. Others may be operated through on-off controls, but the spool actuation has no influence on the spool function itself. What functions are controlled proportionally and which ones are on-off may be determined based on the user's preference and/or budget and/or requirement. Typical functions found on plough sander trucks are: wing front post lift, wing rear lift, reversible front plough, variable pitch front plough, front plough lift, banking tower, under body scraper lift, under body left-right orientation, quick hitch lock-unlock, roll-on-roll-off winch, roll-on-roll-off locking pins, detachable harness tilt, dump body hoist, inside lift for side dump four season bodies, and the like. Usually not all the above listed functions are present on any given equipment.

As described further below, various trials were performed on hydraulic systems to determine acceptable characteristics.

First trials with two Salami VD06 function valves with standard parallel cylinder spools were conducted by installing a power beyond feature in the outlet block of the valve and connecting a Parker DH103C16 stroke valve installed in a standard C4-10 body. The DH103C16 pilot port was connected to this power beyond port. The remaining ports of the DH103C16 were connected as outlined above. The test was a success in the sense that the pump stroked and increased its pressure to compensator setting. On the other hand the spool stroke was close to its end before the pump pressure increased. Therefore this configuration had no metering at all, but proved the feasibility of stroking the pump by blocking the neutral passage of the valve.

The second series of trials with modified spools confirmed the original results and improved on them. These spools closed the neutral passage at exactly the same moment the parallel passage opened to the work port. This resulted in the pump stroking with a slight delay when compared to the opening of the parallel to work port passages. This behaviour is quite logic as the leakage flow around the spool must fall below the saturation of orifice OB as illustrated in the schematics. When the pump pressure increased to its high pressure stand-by, flow out the work port was at three GPM, with further spool movement increasing this flow very precisely. It is desirable to have metering below 3 GPM.

The third set of trials involved spools where the neutral passage closed 0.5 mm before the parallel passage connects to the work ports. In this configuration we saw the pump pressure increase shortly after the spool moves out of its neutral position. Work port flow starts very progressively when the spool moves slightly further, and then increases as spool travel increases, exactly as hoped for. The sample spools gave flows from 0 to 21 GPM, with no load pressure, but these numbers depend on the machining of the spools and body and the limited flow available from the pump of the test bench

As described above, the distance the spool must travel between closing the neutral passage and connecting the parallel passage to the work ports may vary depending on the requirements for metering. Furthermore, the distance may vary depending on the valve size, machining precision of the valve and valve block and the overall system requirements.

The flow out of the work ports revealed itself to be not completely pressure independent, but more pressure differential independent than anticipated As the pump inlet pressure is constant at the pump high pressure stand-by setting, varying the pressure on the work port side between 500 and 1500 PSI resulted in flow variations of no more than 15%, which is acceptable for various applications.

The hydraulic system as described may be used advantageously in numerous applications. One application that benefits from the described hydraulic system is the hydraulic system of a vehicle, which has a substantially continuous hydraulic function as well as on-demand hydraulic functions, such as a vehicle used for ploughing and sanding roads. The sander of the vehicle runs substantially continuously at low pressure and flow requirement, economic benefit due to lower fuel consumption may be achieved through the use of a load sensing variable displacement pump. By using the hydraulic system described herein, the same load sensing pump may be used to control other hydraulic functions of the vehicle, such as raising and lowering of the plough, which are intermittent and require much higher flows and pressures. These functions are obtained using non-load sensing valves that close the neutral passage before connecting the parallel passage.

While the invention has been described according to what is presently considered to be the most practical and illustrative embodiments, it must be understood that the invention is not limited to the disclosed embodiments. Those ordinarily skilled in the art will understand that various modifications and equivalent structures and functions may be made without departing from the spirit and scope of the invention as defined in the claims

What is claimed is:

1. A hydraulic system for operating hydraulic functions comprising:
a reservoir for hydraulic fluid;
a load sensitive variable displacement pump, controllable by a load sensing signal, for pumping hydraulic fluid from the reservoir;
a valve block comprising a function valve controlling flow of the hydraulic fluid from the pump to a hydraulic function through movement of a spool between a plurality of positions comprising:
a first position allowing the hydraulic fluid to flow through a neutral passage of the valve block and stopping the flow of the hydraulic fluid to the hydraulic function; and
a second position stopping the flow of the hydraulic fluid through the neutral passage and allowing the hydraulic fluid to flow to the hydraulic function,
wherein the spool stops the flow of the hydraulic fluid through the neutral passage before allowing the hydraulic fluid to flow to the hydraulic function when the spool is moved from the first position to the second position; and
a hydraulically piloted stroke valve, for providing the load sensing signal to the load sensing pump, the stroke valve having a spool moveable between a plurality of positions comprising:
a first position in which hydraulic fluid under pressure from the pump is connected to the output of the stroke valve providing the load sensing signal; and
a second position in which the output of the stroke valve is connected to a hydraulic fluid return line for returning hydraulic fluid to the reservoir; and
an pilot port connected to the neutral passage of the valve block for moving the spool of the stroke valve between the first and second positions.

2. The hydraulic system of claim 1, wherein the valve block comprises a plurality of function valves, each controlling flow of the hydraulic fluid from the pump to a respective hydraulic function through movement of a respective spool between a plurality of positions comprising:
a first position allowing the hydraulic fluid to flow through the neutral passage of the valve block and stopping the flow of the hydraulic fluid to the respective hydraulic function; and
a second position stopping the flow of the hydraulic fluid through the neutral passage and allowing the hydraulic fluid to flow to the respective hydraulic function,
wherein the respective spool stops the flow of the hydraulic fluid through the neutral passage before allowing the hydraulic fluid to flow to the respective hydraulic function when the spool is moved from the first position to the second position.

3. The hydraulic system of claim 1, wherein the stroke valve is incorporated into one of:
an inlet cover of the function valve body; and
an outlet cover of the function valve body.

4. The hydraulic system of claim 1, further comprising:
a load sensing function valve for controlling flow of the hydraulic fluid to a continuous hydraulic function; and
a shuttle valve for providing the load sensing signal to the pump, the load sensing signal being the higher pressure of either the load sensing signal of the load sensing function valve or the load sensing signal of the stroke valve.

5. The hydraulic system of claim 1, further comprising a means for bleeding off hydraulic fluid used to pilot the stroke valve when the neutral passage of the function valve block is closed.

6. The hydraulic system of claim 5, wherein the means for bleeding off hydraulic fluid includes an orifice coupled to the pilot port of stroke valve.

7. The hydraulic system of claim 1, further comprising a secondary shuttle valve for providing the higher pressure of the load sensing signal of the function valve block or an external load sensing signal to the pump as the load sensing signal.

8. The hydraulic system of claim 1, wherein the spool of the function valves stops the hydraulic fluid flowing in the neutral passage 0.5 mm before allowing the hydraulic fluid to flow to the hydraulic function.

9. The hydraulic system of claim 2, wherein the spool of each of the function valves stops the hydraulic fluid flowing in the neutral passage 0.5 mm before allowing the hydraulic fluid to flow to the hydraulic function.

10. The hydraulic system of claim 2, wherein the function valves comprise valves of different sizes.

11. The hydraulic system of claim 1, wherein the hydraulic function controlled by the function valve include:
wing front post lift wing rear lift;
reversible front plough;
variable pitch front plough;
front plough lift;
banking tower;
under body scraper lift;
under body left-right orientation;
quick hitch lock-unlock;
roll-on-roll-off winch;
roll-on-roll-off locking pins;
detachable harness tilt;
dump body hoist; or
inside lift for side dump four season body

12. The hydraulic system of claim 4, wherein the load sensing function valve controls flow of the hydraulic fluid to a sander or a spreader.

13. A valve block for use with a load sensing pump, the valve block comprising:
a function valve for controlling flow of hydraulic fluid to a hydraulic function through movement of a spool between a plurality of positions comprising:
a first position allowing hydraulic fluid to flow through a neutral passage of the valve block and stopping the flow of hydraulic fluid to the hydraulic function; and
a second position stopping the flow of hydraulic fluid through the neutral passage and allowing hydraulic fluid to flow to the hydraulic function,
wherein the spool stops the flow of hydraulic fluid through the neutral passage before allowing hydraulic fluid to flow to the hydraulic function when the spool is moved from the first position to the second position; and
a hydraulically piloted stroke valve, for providing the load sensing signal, the stroke valve having a spool moveable between a plurality of positions comprising:
a first position in which hydraulic fluid under pressure is connected to the output of the stroke valve providing the load sensing signal; and
a second position in which the output of the stroke valve is connected to a hydraulic fluid return line; and
a pilot port connected to the neutral passage of the valve block for moving the spool of the stroke valve between the first and second positions.

14. The valve block of claim 13, further comprising a plurality of function valves, each controlling flow of the hydraulic fluid from the pump to a respective hydraulic function through movement of a respective spool between a plurality of positions comprising:
a first position allowing the hydraulic fluid to flow through the neutral passage of the valve block and stopping the flow of the hydraulic fluid to the respective hydraulic function; and
a second position stopping the flow of the hydraulic fluid through the neutral passage and allowing the hydraulic fluid to flow to the respective hydraulic function,
wherein the respective spool stops the flow of the hydraulic fluid through the neutral passage before allowing the hydraulic fluid to flow to the respective hydraulic function when the spool is moved from the first position to the second position.

15. The valve block of claim 13, further comprising one of:
an inlet cover incorporating the stroke valve; and
an outlet cover incorporating the stroke valve.

16. The valve block of claim 13 further comprising:
a load sensing function valve for controlling flow of hydraulic fluid to a continuous hydraulic function; and
a shuttle valve for providing the load sensing signal, the load sensing signal being the higher pressure of either the load sensing signal of the load sensing function valve or the load sensing signal of the stroke valve.

17. The valve block of claim 13, further comprising a means for bleeding off hydraulic fluid used to pilot the stroke valve when the neutral passage of the function valve block is closed.

18. The valve block of claim 13, wherein the spool of the function valves stops the hydraulic fluid flowing in the neutral passage 0.5 mm before allowing the hydraulic fluid to flow to the hydraulic function.

19. The valve block of claim 14, wherein the spool of each of the function valves stops the hydraulic fluid flowing in the neutral passage 0.5 mm before allowing the hydraulic fluid to flow to the hydraulic function.

20. The valve block of claim 14, wherein the function valves comprise valves of different sizes.
